(19) United States
(12) Patent Application Publication
(10) Pub. No.: US 2011/0145470 A1
(43) Pub. Date: Jun. 16, 2011

(54) DATA INPUT/OUTPUT DEVICE FOR ADJUSTING CHARACTERISTIC OF INTERFACE

(76) Inventors: Toshinori ARAI, Komae (JP); Seiji Inaba, Yokohama (JP)

(21) Appl. No.: 12/958,633

(22) Filed: Dec. 2, 2010

(30) Foreign Application Priority Data
Dec. 15, 2009 (JP) 2009-284198

(51) Int. Cl. G06F 13/36

(52) U.S. Cl. 710/314

(57) ABSTRACT

To adjusts protocol and analog characteristics of an interface automatically, there is provided a data input/output device coupled to a host computer for inputting and outputting data to and from the host computer, including: an interface coupled to an interface of the host computer; and a controller for controlling the interface of the data input/output device, wherein the controller is configured to: measure an analog characteristic of the interface of the host computer and a protocol characteristic of the interface of the host computer when the data input/output device is reset; and adjust an analog characteristic of the interface of the data input/output device to an optimum value based on a result of the measurement, and then adjust a protocol characteristic of the interface of the data input/output device to an optimum value.

### CLAIM OF PRIORITY

The present application claims priority from Japanese patent application JP 2009-284198 filed on Dec. 15, 2009, the content of which is hereby incorporated by reference into this application.

### BACKGROUND OF THE INVENTION

This invention relates to a data input/output device, and in particular, relates to adjustment of characteristics of an interface, typically for an optical disc drive.

Recently, SATA (Serial Advanced Technology Attachment) interfaces are commonly used for connecting between computers and peripheral devices (for example, optical disc drives and hard disk drives), which are to input/output data to and from the computers. In the connection between a computer and a peripheral device with a SATA interface, even though analog characteristics and protocol characteristics of the chip set (the South Bridge) and the BIOS used in the computer conform to the SATA standard, they are slightly different depending on the computer and the peripheral device. The difference in analog characteristics comes out in the threshold level for evaluation of analog signal amplitude or transmission and reception timing and the difference in protocol characteristics comes out in the interpretation of the SATA regulation, in a special function provided by a chip set, or as a bug in the chip set. For this reason, in some combination of a computer and a peripheral device, protocol characteristics or analog characteristics of the computer do not match those of the peripheral device in communication using a SATA, so that the computer and the peripheral device might not be able to communicate.

Conventionally, when communication is unavailable because of the above-described mismatch of the protocol characteristics or analog characteristics, engineers analyzes the protocol characteristics and analog characteristics of the computer and the peripheral device with a measurement device and modifies firmware. For this reason, a technique has been desired that automatically adjusts interface characteristics.

As a technique to adjust such interface characteristics, JP 2009-529289 A discloses a technique that modifies receiving characteristics adaptively with reference to the information which a master device receives from a slave device through one or more one-way data paths before modifying transmission characteristics adaptively.

In the meanwhile, regarding the SATA interface, JP 2009-141722 A discloses a self adjustment mechanism for an amplitude evaluation module and a time evaluation module in a SATA interface. JP 2009-130614 A discloses a communication control device for a SATA interface that changes the setting of the transmission module if a host computer returns a receive error.

As described above, there exists conventional art that adjusts analog characteristics of SATA. However, the above conventional art documents merely disclose modifying the analog characteristics of an interface, but none of them discloses adjusting protocol settings, or the digital characteristics, of SATA.

The digital characteristics need to be adjusted after analog adjustment, such as signal level adjustment, has been completed. The sequence, however, has not been considered in the conventional art.

An object of this invention is to provide a peripheral device like an optical disc drive that adjusts protocol characteristics and analog characteristics in communication using a SATA interface automatically, but without assistance of engineers.

### SUMMARY OF THE INVENTION

A representative aspect of this invention is as follows. That is, there is provided a data input/output device coupled to a host computer for inputting and outputting data to and from the host computer, including: an interface coupled to an interface of the host computer; and a controller for controlling the interface of the data input/output device. The controller measures an analog characteristic of the interface of the host computer and a protocol characteristic of the interface of the host computer when the data input/output device is reset; and adjusts an analog characteristic of the interface of the data input/output device to an optimum value based on a result of the measurement, and then adjusts a protocol characteristic of the interface of the data input/output device to an optimum value.

According to an aspect of this invention, communication with a host computer can be established in proper condition regardless of the characteristics of the host computer.

### BRIEF DESCRIPTION OF THE DRAWINGS

The present invention can be appreciated by the description which follows in conjunction with the following figures, wherein:

FIG. 1 is a block diagram illustrating a configuration of an optical disc drive in an embodiment of this invention;

FIG. 2 is a block diagram illustrating a configuration of the interface in this embodiment of this invention;

FIG. 3 is a flowchart of an analog adjustment procedure in this embodiment of this invention; and

FIG. 4 is a flowchart of a protocol adjustment procedure in this embodiment of this invention.

### DETAILED DESCRIPTION OF THE EMBODIMENTS

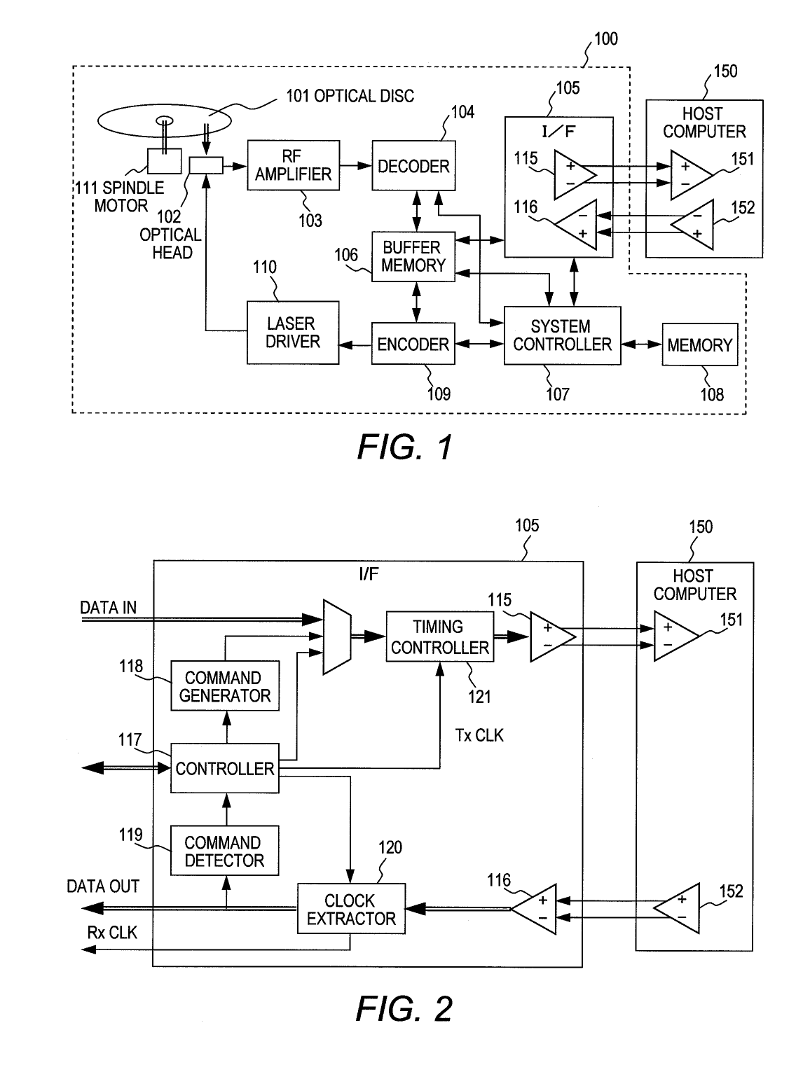

FIG. 1 is a block diagram illustrating a configuration of an optical disc drive 100 in an embodiment of this invention.

The optical disc drive 100 in this embodiment comprises an optical head 102, an RF amplifier 103, a decoder 104, an interface 105, a buffer memory 106, a system controller 107, a memory 108, an encoder 109, a laser driver 110, and a spindle motor 111.

The optical disc drive 100 is coupled to a host computer 150 via the interface 105 and outputs data read from a loaded optical disc 101 (for example, a Blu-ray Disc) to the host computer 150. The optical disc drive 100 may have a function of writing data received from the host computer 150 onto a writable optical disc 101. The spindle motor 111 rotates and drives the optical disc 101.

To play data on the optical disc 101, the optical head 102 irradiates the optical disc 101 with weak laser light and reads data recorded on the optical disc 101 with reflection of the laser light to output an RF signal corresponding to the reflection. To write data onto the optical disc 101, the optical head 102 irradiates the optical disc 101 with more intensive laser light than in reading data therefrom. By thermal phase-change at the spot on which the laser light impinges on the optical disc 101, a recording pit is formed on the recording layer. The recording pit changes the reflectance of the recording layer to record data.

The RF amplifier 103 amplifies an RF signal inputted from the optical head 102 and outputs the amplified RF signal as a digital data. The decoder 104 demodulates the digital data outputted from the RF amplifier 103 in accordance with the format specified depending on the type of optical disc, performs error detection and error correction on it, and then temporarily stores the demodulated data in the buffer memory 106.

The interface 105 controls transmitting and receiving data and command between the optical disc drive 100 and the host computer 150 connected therewith. The configuration of the interface 105 will be described later with reference to FIG. 2. The buffer memory 106 temporarily stores data which is received from the host computer 150 via the interface 105 to be recorded to the optical disc 101.

The encoder 109 generate modulated signals from the data inputted from the host computer 150 and temporarily stored in the buffer memory 106 in accordance with the format specified depending on the type of optical disc. The laser driver 110 outputs a signal for driving a laser light source in the optical head 102.

The system controller 107 is a microprocessor for controlling operations of the optical disc drive 100 and controls operations of the decoder 104, the encoder 109, and the interface 105. The system controller 107 further controls reading of data temporarily stored in the buffer memory 106 and writing of data to the buffer memory 106. In addition, the system controller 107 interprets a command received from the host computer 150 and processes the received command.

The memory 108 stores data necessary for the system controller 107 to execute processes and data generated through the processes. The memory 108 includes a non-volatile memory area for storing the settings and logs of a SATA interface, which will be described later.

FIG. 2 is a block diagram illustrating a configuration of the interface in this embodiment.

The interface 105 comprises a transmission signal driver 115, a receiving signal driver 116, a communication controller 117, a command generator 118, a command detector 119, a clock extractor 120, and a timing controller 121.

The transmission signal driver 115 generates an analog signal to be transmitted to the host computer 150. The receiving signal driver 116 receives an analog signal transmitted from the host computer 150. The communication controller 117 controls communication with the host computer 150 in accordance with a specified protocol. The optical disc drive 100 in this embodiment communicates with the host computer 150 in accordance with the SATA protocol.

The command generator 118 holds fixed patterns of commands to be transmitted to the host computer 150 and generates a command to be transmitted in accordance with an instruction from the communication controller 117. The command detector 119 holds fixed patterns of commands to be transmitted from the host computer 150 and compares a received signal with the stored patterns. If the received signal matches a pattern of the stored patterns, the command detector 119 detects a receipt of a command and transmits the detected command to the communication controller 117.

The clock extractor 120 extracts a specified synchronization pattern from a signal received from the host computer 150 to create a clock signal for decoding the received signal. The timing controller 121 controls transmission timing of data and command to be transmitted to the host computer 150 with a transmission clock signal generated by the communication controller 117.

Commands to be transmitted by the transmission signal driver 115 are created in accordance with instructions by the communication controller 117 and data to be transmitted by the transmission signal driver 115 are read from the buffer memory 106. A command received by the receiving signal driver 116 is sent to the communication controller 117 and data received by the receiving signal driver 116 is stored to the buffer memory 106.

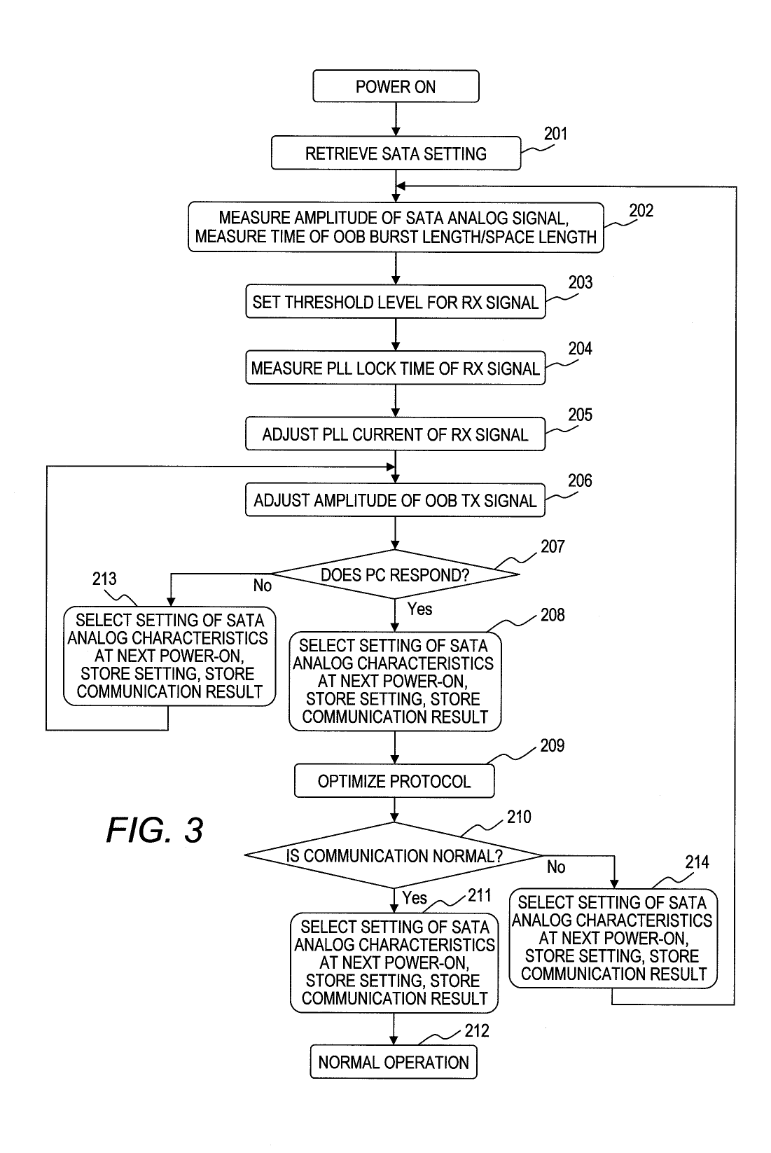

FIG. 3 is a flowchart of an analog adjustment procedure in this embodiment.

This analog adjustment procedure is executed by the system controller 107, but may be executed by the communication controller 117 in the interface 105.

At a power-on, the system controller 107 retrieves the current SATA setting including receiving signal threshold level, PLL characteristic, transmission signal amplitude, and others (201). Standard values are stored in the memory 108 in the factory default setting, and at the next shut-down, the values in use are stored to the memory. Accordingly, at the next power-on, the values at the last shut-down are set.

Next, the system controller 107 measures the amplitude of an analog signal transmitted from the host computer 150 (202). Then, it sets a threshold level for the receiving signal with reference to the measured amplitude (203). Specifically, a certain fraction of the peak of the receiving signal is set as the threshold level. By changing the value of the fraction, the system controller 107 matches transmission and receiving characteristic of the optical disc drive 100 with transmission and receiving characteristic of the host computer 150.

Next, it measures the PLL lock time of the receiving signal (204). The reason of measuring the PLL lock time is as follows. In OOB (Out-Of-Band) signaling to establish communication between the host computer 150 and a peripheral device, allowable time for receiving an OOB signal transmitted from the peripheral device responsive to an OOB signal transmitted from the host computer 150 is different depending on the chip set or the BIOS (Basic Input/Output System) of the host computer 150. To establish communication between the host computer 150 and the peripheral device, the peripheral device has to respond to an OOB signal transmitted from the host computer 150 with appropriate timing. For this reason, the system controller 107 measures the PLL lock time to adjust the PLL lock time for generating an OOB signal synchronized to the OOB signal transmitted from the host computer 150.

Next, the system controller 107 adjusts the PLL current for the receiving signal (205). Specifically, it changes current supplied to a charge pump within an allowable range to change the PLL lock time. In changing the current, the system controller 107 initially sets a standard current value which is supposed to be the optimum value and then increases or decreases the current value in a predetermined pattern depending on a response from the host computer 150.

Then, the system controller 107 adjusts the amplitude of the OOB signal transmitted from the optical disc drive 100 (206). This OOB transmission signal is a signal exchanged when the host computer 150 and the optical disc drive 100. In adjusting the amplitude of the OOB signal, the system controller 107 initially sets a standard amplitude which is supposed to be the optimum value and increases or decreases the amplitude in a predetermined pattern.

In setting the threshold level of the receiving signal (203), adjusting the PLL of the receiving signal (205), and adjusting the amplitude of the OOB signal (206), the system controller 107 selects values from a preset table to set the SATA characteristics. This table is stored in the non-volatile memory area of the memory 108. The system controller 107 may select values from the table in a predetermined order at every time the optical disc drive 100 is reset. Otherwise, it may increase or decrease the values or determine the amount to be adjusted with reference to the SATA setting and the communication quality contained in a log stored at the step 211.

Then, the system controller 107 sends an OOB signal to the host computer 150 and determines whether to receive a response from the host computer 150 within a predetermined period (207).

As a result, if it does not receive a response from the host computer 150 within the predetermined period, it selects the setting of the analog characteristics of SATA (namely, the values to be used in the next power-on), stores the selected values to the memory, stores the communication result to the memory as a log (213), and returns to the step 206 to readjust the amplitude of the OOB signal.

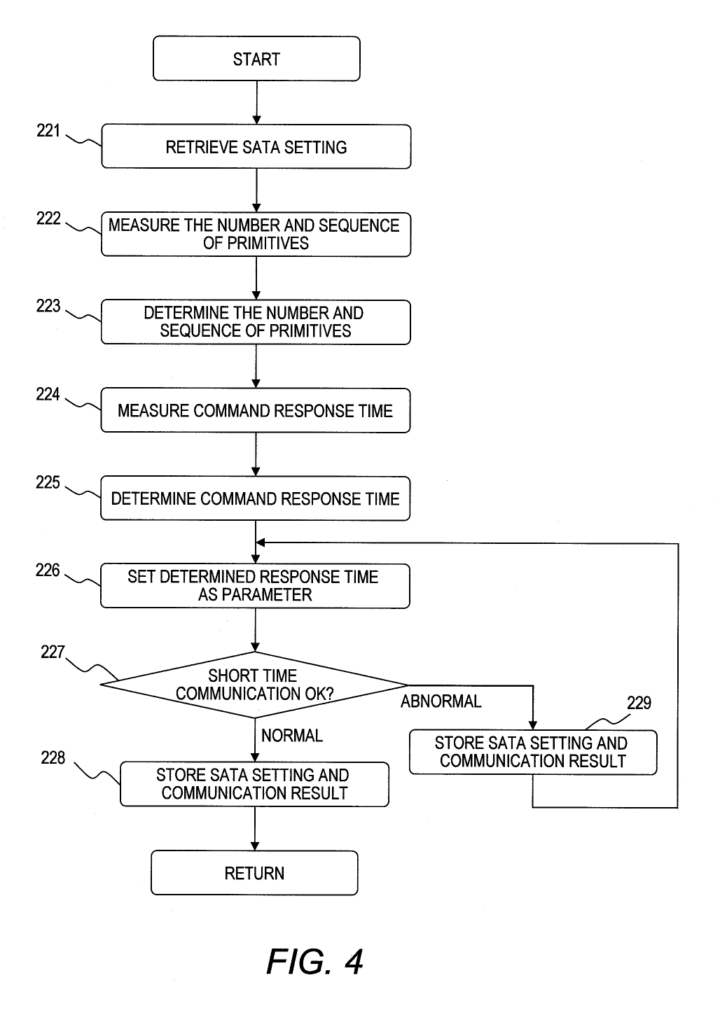

On the other hand, if the system controller 107 receives a response from the host computer 150, it selects the setting of the analog characteristics of SATA (namely, the values to be used in the next power-on), stores the selected value to the memory, and stores the communication result to the memory as a log (208). Then, it optimizes the protocol characteristics of the transmission signal (209). This protocol adjustment will be explained with reference to FIG. 4.

Next, the system controller 107 determines whether the communication with the host computer 150 is normal (210). This determination is preferably made after a comparatively long monitoring period (for example, longer than one minute). Specifically, it determines whether any trouble exists for practical communication depending on command error rate within a specific time period or whether the system controller 107 receives an error from the host computer 150 responsive to a primitive, an FIS (Frame Information Structure), or an ATA/ATAPI (Advanced Technology Attachment/AT Attachment Packet Interface) command, for example. It is preferable that the determination be performed on not only the lower layers such as the physical layer and the link layer, but also on the upper layers such as the transport layer and the application layer. This is because determination on the upper layers leads to determination based on the availability of actual communication.

If the communication has been determined to be normal, the system controller 107 selects the setting of the analog characteristics of SATA (the setting to be used at the next power-on), stores the selected setting to the memory, stores the communication quality to the memory as a log (211), and the optical disc drive starts normal operations (212).

On the other hand, if the communication is not normal, the system controller 107 selects the setting of the analog characteristics of SATA (the setting to be used at the next power-on), stores the selected setting to the memory, and stores the communication quality to the memory as a log (214). Simultaneously, it refers to the preliminarily prepared table or a stored log to perform setting for the next start-up. The OOB signal is a special signal indicating a start of communication and is composed of a pattern of burst signal and two patterns of space signals. There are two kinds of OOB signals, COMRESET and COMWAKE, depending on the space length. At the step 202 in FIG. 3, the system controller 107 measures the time of a burst length and the time of a space length in the OOB pattern together with the amplitude of the OOB signal to identify the signal as a COMRESET, a COMWAKE, or another signal. In receiving and transmitting primitives after communication has been established through OOB signaling, commands arrive faster than in the OOB signaling. Accordingly, the acquisition rate of commands might be insufficient although the communication has been established through OOB signaling. In such a case, the system controller 107 stores a log to the memory 108 to use it as information for determining the setting for the next power-on (or the next COMRESET). When the system controller 107 has determined that the communication is not normal, it determines the setting for the next power-on (or the next COMRESET) with reference to the preliminarily prepared table and stores the values to the memory to be referred to at power-on.

It is preferable to store a plurality of logs in the memory 108 because accurate determination of the optimum condition for the SATA setting can be obtained by referring to a plurality of settings and communication qualities leads to quick.

If the communication is not normal, the host computer 150 cannot access the optical disc drive, so it usually transmits a COMRESET command, which is a signal to initialize the communication with the optical disc drive. Accordingly, the system controller 107 waits for a COMRESET from the host computer 150 at the step 210, returns to the step 202 via the step 214, and executes the processes again starting from measuring the analog signal level.

If the host computer 150 does not transmit the COMRESET command, the user cannot use the optical disc drive 100, so he or she may power on (reboot) the host computer 150 again. In this case, too, the analog adjustment procedure is executed from the beginning as in the case of COMRESET from the host computer 150.

In the analog adjustment procedure shown in FIG. 3, the receiving signal threshold level, the PLL characteristic, and the amplitude of the transmission signal are adjusted. In addition to these, the interval of the signal, the rise time of the signal, the fall time of the signal, pre-emphasis characteristics and others may be adjusted.

FIG. 4 is a flowchart of a protocol adjustment procedure in this embodiment.

This protocol adjustment procedure is called from the step 209 in the analog adjustment procedure shown in FIG. 3.

First, the system controller 107 retrieves the setting for transmitting the protocols of primitives, FISs (Frame Information Structures), and ATA/ATAPI (Advanced Technology Attachment/AT Attachment Packet Interface) commands (numbers of received primitives, FISs, and ATA/ATAPI commands, the sequences of the received primitives, FISs, and ATA/ATAPI commands, and a command response time), which are constituents of the current SATA setting, from the memory 108 (221). The setting of protocols includes the number and the sequence of primitives, FISs, and ATA/ATAPI commands, and command response time. A primitive is a command that is transmitted and received by a SATA to control communication; the number of commands to be transmitted and received is regulated by the SATA. A standard value is stored in the memory 108 at the shipment of an optical disc drive 100 and the value in use is stored to the memory at a subsequent power shut-down. Hence, at the next power-on, the value used at the last power shut-down is set.

Next, the system controller 107 measures the number and the sequence of primitives, FISs, and ATA/ATAPI commands transmitted from the host computer 150 in a specified time period (222). In accordance with the measured number and sequence of primitives, FISs, ATA/ATAPI commands, the system controller 107 determines the number and the sequence of primitives, FISs, and ATA/ATAPI commands to be transmitted from the optical disc drive 100 (223). Specifically, the system controller 107 sets to transmit primitives in the same number and the same sequence as the primitives, FISs, and ATA/ATAPI commands transmitted from the host computer 150.

This is because, the number and the sequence of primitives, FISs, ATA/ATAPI commands actually transmitted and received between a specific host computer 150 and its peripheral device are sometimes different from those specified by the SATA standard, so the number and the sequence of primitives transmitted from the optical disc drive 100 to the host computer 150 are to be met with those from the host computer 150. For example, in the case that the SATA standard regulates to transmit six or more primitives and eight primitives are transmitted, some host computer 150 may not receive them properly. Hence, if the host computer 150 transmits six primitives, it is preferable that the optical disc drive 100 also transmit six primitives. The transmission sequence of command A and command B is arbitrary according to the SATA standard, but some host computer 150 may not receive them unless they are sent in a specified sequence. Hence, this function enables the optical disc drive 100 to transmit commands in the order of the command A and command B if the host computer 150 transmits commands in the order of the command A and the command B.

Next, the system controller 107 measures command response time, which is the time after the optical disc 100 transmits a command until it receives a command responsive thereto from the host computer 150 (224). Then, it determines the response time to a command transmitted from the optical disc drive 100 in accordance with the response time of the host computer 150 (225). It is preferable that the response time of the optical disc drive 100 be set at the same time as the response time of the host computer 150 or the time with a certain time increased to or decreased from the response time of the host computer 150.

The command response time is the time period from transmission of a command by the optical disc 100 to receipt of a response from the host computer 150. The SATA standard specifies a standard command response time, but allowable command response time differs depending on the host computer 150. Accordingly, the system controller 107 measures the time required for the host computer 150 to respond to a command and sets to respond to the command in the same time period of the measured time.

Next, the system controller 107 sets the determined command response time as a parameter (226). In this event, the system controller 107 may slightly adjust the parameter depending on the time required for the command processing. For example, for a command that requires a long time to be processed, the system controller 107 sets a shorter time than the measured command response time.

Then, it determines whether or not short time communication (for example, approximately from one millisecond to one second) with the host computer 150 is performed normally (227).

As a result, if the optical disc drive 100 cannot receive a response to the command from the host computer 150, the communication is not normal. Accordingly, the system controller 107 stores the SATA setting and the communication result as a log to the memory (229), returns to the step 226, and slightly adjusts the parameter with the command response time set. This is because, in a case where a host computer 150 does not accept a command even if the command response time is set at the same time as that of the host computer 150, the system controller 107 searches for the timing allowable to the host computer 150 by increasing or decreasing the command response time to respond to the command within the allowable time period.

On the other hand, if the system controller 107 receives a response to a command from the host computer 150, the short time communication is normal. So, it stores the SATA setting and the communication result as a log to the memory (228), and then terminates the protocol adjustment to return to the analog adjustment 210.

In this embodiment, settings of analog characteristics and protocol characteristics of SATA and communication results are stored in the memory (208, 211, 213, 214, 228, and 229). The log stored in the memory may be outputted from the interface 105. Such a configuration can provide the cause why the optical disc drive 100 cannot communicate with the host computer 150 and the course how the optical disc drive 100 has reached the optimum setting.

As described above, in this embodiment, the analog characteristics and protocol characteristics of SATA are changed at a power-on (or a reset by a reset signal) to adjust communication condition between a host computer and an optical disc drive. Accordingly, the host computer 150 can select more suitable condition by transmitting a reset signal to the optical disc drive 100, re-powering on the optical disc drive 100, or re-powering on the host computer 150.

The selected optimum condition is stored in a flash memory (a non-volatile memory medium), which is a part of the memory 108, and are used as the initial setting at the next power-on. Consequently, the optical disc drive 100 can communicate with any host computer 150 with fewer errors in a better environment.

The optical disc drive 100 may send the data of the selected condition and a communication result, which have been stored in the memory as a communication log and retrieved from the interface 105, to a remote engineer. Consequently, communication problems can be analyzed without costly measuring equipment in an area where analysis is required.

Although an optical disc drive has been described as an embodiment of this invention, this invention may be applied to not only an optical disc drive but also other peripheral device inputting and outputting data to and from a host computer, such as a magnetic disk drive, a non-volatile storage drive (for example, an SSD: Solid State Drive), or the like.

Although the SATA interface has been described as an embodiment of this invention, this invention may be applied to other serial communication such as USB, HDMI, SAS, EtherNet, PCI-Express, or the like, but is not limited to the SATA.

While the present invention has been described in detail and pictorially in the accompanying drawings, the present invention is not limited to such detail but covers various obvious modifications and equivalent arrangements, which fall within the purview of the appended claims.

What is claimed is:

1. A data input/output device coupled to a host computer for inputting and outputting data to and from the host computer, comprising:
an interface coupled to an interface of the host computer; and
a controller for controlling the interface of the data input/output device,
wherein the controller is configured to:
measure an analog characteristic of the interface of the host computer and a protocol characteristic of the interface of the host computer when the data input/output device is reset; and
adjust an analog characteristic of the interface of the data input/output device to an optimum value based on a result of the measurement, and then adjust a protocol characteristic of the interface of the data input/output device to an optimum value.

2. The data input/output device according to claim 1, wherein:
the controller measures at least one of the numbers of received primitives, FISs, and ATA/ATAPI commands, the sequences of the received primitives, FISs, and ATA/ATAPI commands, and a command response time of the computer as the protocol characteristic of the interface of the host computer; and
the controller adjusts at least one of the number of primitives to be transmitted, the sequence of the primitives to be transmitted, and a command response time of the data input/output device based on the result of the measurement.

3. The data input/output device according to claim 1, wherein:
the controller measures at least one of an amplitude of a receiving signal and synchronization acquisition time of the receiving signal as the analog characteristic of the interface of the host computer; and
the controller adjusts at least one of an amplitude of a signal to be transmitted and synchronization acquisition time of the interface of the data input/output device based on a result of the measurement.

4. The data input/output device according to claim 1, further comprising a non-volatile memory,
wherein the controller stores the adjusted analog characteristic and protocol characteristic into the non-volatile memory.

5. The data input/output device according to claim 4, wherein:
the controller stores the analog characteristic of the interface which has been adjusted to the optimum value and the protocol characteristic of the interface which has been adjusted to the optimum value into a preset table stored in the non-volatile memory in a case where the data input/output device is powered on or the data input/output device receives a reset signal from the host computer; and
the controller starts up the interface adjusted at the stored optimum values in a case where the data input/output device cannot communicate normally with the host computer for a predetermined time period, the data input/output device is powered on again, or a reset signal is received from the host computer.
